(19) United States
(12) Patent Application Publication
(10) Pub. No.: US 2008/0167911 A1
(43) Pub. Date: Jul. 10, 2008

(54) Scheduling integration for providing business automation

(75) Inventor: Darrin N. Hatakeda, Redmond, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/651,805

(22) Filed: Jan. 9, 2007

(51) Int. Cl. G06Q 10/00

(52) U.S. Cl. 705/5; 705/9

(57) ABSTRACT

Scheduling integration is provided for business automation. Schedules and rules are set up for entities of a service business. When scheduling modifications are received, the schedules and rules for the service entities are considered for conflict. When a conflict does not exist, the scheduling modifications are associated with the schedules for the service entities. The scheduling histories are tracked and the tracked scheduling histories are leveraged by business automation utilities to provide automated tools-to the service business. In this manner, global scheduling is automated, scheduling modifications are automated and scheduling histories are leverage by business automation utilities. Thus, business efficiency increases and customer experience is enhanced.

### BACKGROUND

Scheduling is a major business component for service based companies. Typically, companies, employees, resources and customers require scheduling. Such scheduling is typically disjoint in that they are not used as factors for global management of a service based company. Also, scheduling information is tracked independently and not integrated into other systems so companies are not able to leverage the scheduling information. From the standpoint of a business customer, making reservations with a service based company may be difficult. From the standpoint of the business owner, business management, customer management, employee management, and resource management is labor intensive, time consuming, inefficient and leads away from customer satisfaction and increased sales.

### SUMMARY

This Summary is provided to introduce a selection of concepts in a simplified form that are further described below in the Detailed Description. This Summary is not intended to identify key and/or essential features of the claimed subject matter. Also, this Summary is not intended to limit the scope of the claimed subject matter.

The disclosure relates to scheduling integration for providing business automation. Schedules and rules are set up for entities of a service business. When scheduling modifications are received, the schedules and rules for the service entities are considered for conflict. When a conflict does not exist, the scheduling modifications are automatically associated with the schedules for the service entities. The scheduling histories are tracked and the tracked scheduling histories are leveraged by business automation utilities to provide automated tools to the service business.

In this manner, global management is automated, scheduling modifications are automated and scheduling histories are leveraged by business automation utilities. Thus, business efficiency increases and customer experience is enhanced.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 represents one exemplary system overview for scheduling integration for providing business automation;

FIG. 2 represents a top level operational flow diagram for scheduling integration for providing business automation;

FIG. 3 represents an operational flow diagram for setting a business service schedule and business service rules;

FIG. 4 represents an operational flow diagram for setting an employee schedule and employee rules;

FIG. 5 represents an operational flow diagram for setting a resource schedule and resource rules;

FIG. 6 represents an operational flow diagram for setting a customer schedule and customer rules;

FIG. 7 represents an operational flow diagram for receiving a customer schedule and updating the service business;

FIG. 8 represents an operational flow diagram for modifying an employee schedule;

FIG. 9 represents an operation flow diagram for modifying a resource schedule;

FIG. 10 represents an operation flow diagram for modifying a business services schedule;

FIG. 11 represents an operation flow diagram for utilizing a business automation utility; and

FIG. 12 represents an exemplary computing device.

### DETAILED DESCRIPTION

Embodiments are described more fully below with reference to the accompanying drawings, which form a part hereof, and which show specific exemplary embodiments. However, embodiments may be implemented in many different forms and should not be construed as limited to the embodiments set forth herein; rather, these embodiments are provided so that this disclosure will be thorough and complete, and will fully convey the scope. Embodiments may be practiced as methods, systems or devices. Accordingly, embodiments may take the form of an entirely hardware implementation, an entirely software implementation or an implementation combining software and hardware aspects. The following detailed description is, therefore, not to be taken in a limiting sense.

The logical operations of the various embodiments are implemented (1) as a sequence of computer implemented steps running on a computing system and/or (2) as interconnected machine modules within the computing system. The implementation is a matter of choice dependent on the performance requirements of the computing system implementing the invention. Accordingly, the logical operations making up the embodiments described herein are referred to alternatively as operations, steps or modules.

In small to medium sized service businesses, customer relations management and employee management is difficult. Typically, scheduling for appointments, scheduling for the business, scheduling for the employees, and scheduling for resources are disjoint. The disjoint scheduling causes scheduling conflicts with the global management of the business service. For example, a customer may change a reservation with a service business; however, an appropriate employee may not be scheduled to work during the changed reservation time or be properly notified of the change. The disjoint scheduling also makes schedule modifications labor intensive because several business entities may need to be contacted and updated. For example, an employee may become sick. The owner is then required to manually find a new employee for the slot or manually contact a customer to reschedule the appointment. Also, scheduling data is not utilized in an effective manner because collecting the data from the disjoin business entities is time consuming. For example, if an owner wants to send a custom survey to a customer, the owner must obtain the customer data, obtain the service schedule for the customer, obtain the employee schedule associated with the customer, obtain the resource schedule associated with the customer and then manually generate a custom survey to send to the customer.

The present disclosure provides embodiments for integrating the schedules of several entities of a service business. For example, customer scheduling, business scheduling, resource scheduling and employee scheduling are integrated to communicate respective changes. As such, appropriate schedules automatically populate when a reservation is received. Also, modifications may be automatic to populate changes to all interested entities of a service business. For example, an employee having a service duty may indicate a sick day on an employee schedule. The employee schedule automatically schedules another employee for the service duty, updates the business schedule and notifies the customer of the change. Scheduling rules may also be provided to allow the automatic scheduling to be tailored by an owner. As an example, an owner may implement a scheduling rule that all first time customers are serviced by the owner and not another employee. When a first time customer makes a reservation, only the owners schedule will be populated for the reservation. Also, the data obtained from the scheduling of the business entities may be leveraged to provide an output for a business automation utility. For example, a business service may desire sending a customized survey. The business automation utility obtains data from the customer schedule, business schedule, employee schedule and resource schedule to populate a survey custom to the appointment.

In this manner, scheduling is integrated, custom relations management is enhanced, employee relations management is enhance and scheduling data may be leveraged to provide enhanced business utilities.

Throughout the specification, an example of a hair salon is used. The hair salon example is for exemplary purposes only and not meant for limiting the disclosure in any manner. A business service may include any combination or type of services and/or retail.

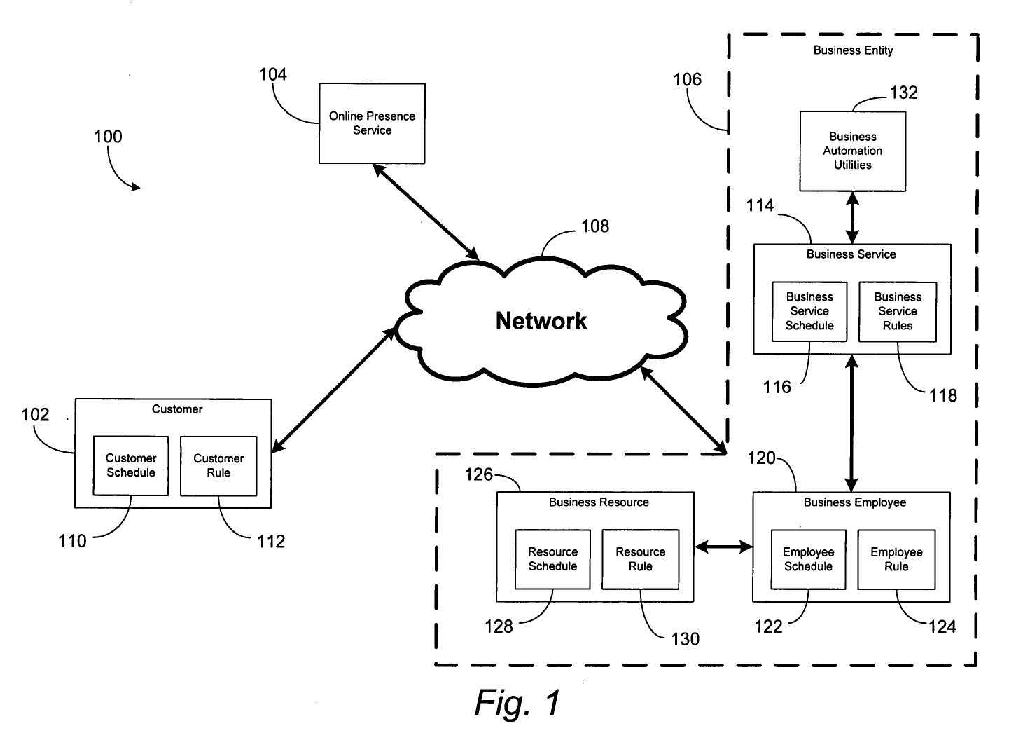

FIG. 1 represents one exemplary system overview for scheduling integration for providing business automation. System 100 represents a modular overview of a computing environment. System 100 may include customer 102, online presence service 104, business entity 106, and network 108. Customer 102, online presence service 104, and business entity 106 may be associated with a server and/or a computing device. The computing device may include a desktop computing device, mobile computing device, a laptop, a personal digital assistant, a notebook computer, and/or any other type of computing device functional to store data. In one aspect, the computing device includes computing device 100 as exemplified in FIG. 1.

System 100 may include online presence service 104. Online presence service 104 may include a domain, web site, email accounts, management applications and tools. Online presence service 104 may include a server for providing Internet business services for business entity 106. In one embodiment, business entity 106 hosts online presence service 104. In another embodiment, online presence service 104 is hosted by a third party. In such a situation, online presence service 104 may be associated with a plurality of business entities. Customer 102 is provided online business review information for the plurality of business entities associated with online presence service 104 and customer 102 is provided access to a web site for business entity 106. For example, online presence service 104 may include a suite of hair salons. Each hair salon link may include reviews by users of the hair salon and other information associated with the business. Customer 102 may log onto the suite, read reviews, read ratings, review schedules and pricing, and ultimately log onto a website to make a reservation.

Customer 102 has access to business entity 106 via network 108 and online presence service 104. Customer 102 may include one or more computer systems associated with network 108. For example, customer 102 may include an individual using a home computer and desiring a haircut. Customer 102 logs onto online presences service 104 with a user ID. For example, the user ID may include a password associated with a name and personal data. Online presence service 104 may provide a web page and a reservation service for business entity 106. For example, the reservation service may include a reservation page for selecting a time and date for a haircut. When customer 102 finalizes the reservation, online presence service 104 sends the reservation to business entity 106.

Customer 102 may include customer schedule 110 and customer rule 112. Customer schedule 110 may include a selected reservation sent to the business entity 106. Customer rule 112 includes rules that customer 102 may set to control the interaction between business entity 106 and customer 102. For example, customer rule 112 may include notification rules. Notification rules include requested modes of notification for contacting a customer. The modes of notification may include an email notification, a text message notification, a telephone call notification, a regular mail notification, and/or any other mode of communication for communication between two parties. The notification rules may also be conditional. For example, a customer may set a customer rule that indicates that business entity 106 should first notify by telephone, and if connection is not made, notify by email. Customer rule 112 may also include special requests. For example, a special request may include a request for a particular employee, a request for a particular resource, and/or a request for a particular service. Customer rule 112 may be set by customer 102 to dictate an expected experience with business entity 106.

Business entity 106 has access to customer 102 via network 108 and online presence service 104. Business entity 106 may include one or more computer systems associated with network 108. Business entity 106 is depicted as including several modules including business automation utilities 132, business service 114, business employee 120, and business resource 126. They are depicted herein separately for explanation purposes only. These modules may be a single module or several modules in communication with one another. Likewise, business entity 106 is depicted as including several schedules 1 16, 122, and 128. The schedules are depicted separately for explanation purposes only and may include a single schedule or a plurality of separate schedules in communication with one another. Furthermore, business entity 106 is depicted as having several rules 118, 124, and 130. Again, these rules are depicted separately for explanation purposes only and may include a single rule module or a plurality of rules modules.

Business entity 106 includes business service 114 having business service schedule 116 and business service rules 118. Business service 114 may include a single service or multiple services. For example, business service 114 may include a hair salon, a chain of hair salons, or a nail service entity of a hair salon.

Business service 114 includes business service schedule 116 and business service rules 118. Business service schedule 116 includes the hours and dates of operation for business service 114. Business service schedule 116 may be associated with a spreadsheet application and/or a calendar application for display, manipulation and modification of the business service schedule 116. Business service schedule 116 may be as complex or as simple as the business owner desires. For example, business service schedule 116 may include the days and hours of operation. Business service schedule 116 may also be contingent on business service rules 118. Stated another way, business service rules 118 may dictate business service schedule 116.

Business service rules 118 may include any type of rule for dictating scheduling of business entity 106. Business service rules may be set up to execute on the system of FIG. 1 automatically when conditions are met. Business rules 118 may include rules regarding incoming reservations and the service. For example, business service rule 118 may include “accepting no other reservations when Mr. Hatakeda makes a reservation.” Business service rules 118 may also include rules regarding incoming reservations and employees. For example, business service rules 118 may include that “anytime Mr. Hatakeda makes a reservation the most senior employee handles the reservation.” Business service rules 118 may also include rules regarding incoming reservations and resources. For example, business service rules 118 may include that “anytime Mr. Hatakeda makes a reservation it will take place in the president haircutting suite with the gold hairdryer.” Any combination of business service rules 118 based on the customer 102, business service 114, business employee 120, and business resources 126 is contemplated.

Business entity 106 includes business employees 120 having employee schedules 122 and employee rules 124. Business employees 120 may include one employee or several employees. The employees may be associated with a single business service or several business services of business service 114.

Employee schedule 122 includes work or shift scheduling for the employees. For example, employee schedule may include a spread sheet application and/or calendar application that identifies employees and the hours the employee is working for business service 114. Employee schedule 122 may be contingent on employee rules 124. Stated another way, employee rules 124 may dictate employee schedule 122.

Employee rules 124 may include any type of rule for dictating scheduling of business employee 120. Employee rules may be set up to execute on the system of FIG. 1 automatically when conditions are met. For example, employee rules 124 may allow employees to switch schedules without requiring permission. In such a situation, an employee may log onto the system of FIG. 1 and switch time with another employee. As another example, employee rules 124 may require permission to switch schedules. As another example, employee rules 124 may be contingent. In the hair salon example, the rule may include booking Mr. Hatakeda with the most senior employee if the most senior employee is available, otherwise requesting a second most senior employee. Other employee rules may permit an employee to book vacation time in advance. As another example, an employee rule may include the most senior employee having first rights to the president hairstyling suite when the most senior employee is working. Any combination of employee rules 124 based on the customer 102, business service 114, business employee 120 and business resource 126 is contemplated.

Business entity 106 includes business resource 126 having resource schedule 128 and resource rule 130. Business resource 126 may include one resource or several resources. Also, business resource 126 may include a singe resource type or a plurality of resources.

Resource schedule 128 includes time allocation scheduling for resources of business entity 106. For example, resource schedule 128 may include a spreadsheet application or calendar application that identifies resources and the time and dates that the resources are scheduled for use. Resource schedule 128 may be contingent on resource rules 130. Stated another way, resource rules 130 may dictate resource schedules 128.

Resource rules 130 may include any type of rule for dictating scheduling of business resources 126. Resource rules may be set up to execute on the system of FIG. 1 automatically when conditions are met. For example, a rule may include “automatically booking the president haircutting suite when Mr. Hatakeda makes a reservation.” Another resource rule 130 may include “prohibiting booking of the president haircutting suite during certain hours for cleaning.” Another resource rule 130 may include “only allowing the most senior employee book the president haircutting suite.” Yet another, resource rule 130 may include “always booking the president haircutting suite first” because business entity 106 can charge the most for the president haircutting suite. Any combination of resource rules 130 based on the customer 102, business service 114, business employee 120, and business resource 126 is contemplated.

Business entity 106 includes business automation utilities 132. Business automation utilities 132 track or monitor the association of customer schedule 110, business service schedule 116, employee schedule 122, and resource schedule 128. Data associated with the tracking or monitoring may be utilized by business automation utilities 132. For example, business automation utility 132 may include a calendaring application, a chart application, a spreadsheet application, a survey application, a coupon application, a reward point application, and/or any application configured to utilize data from schedules. For example, a calendaring application may include a calendar having a global schedule for all the entities associated with business entity 106. As another example, a chart application may chart business entities and scheduling in relation to one another. As yet another example, a spreadsheet application may include a spreadsheet of the use of employees and resources over a time period. As still another example, a survey application may be configured to generate a service, customer, employee and resource specific survey. In this manner, a business owner may obtain very specific data of a service. As still another example, a coupon application may be sent to customer 102 according to a specific notification rule associated with customer rule 112. The coupon may also be traceable via a bar code and be transferable. In this manner, customer 102 may transfer the coupon to another individual. When the individual uses business service 114, business service 114 can trace the coupon back to customer 102. As yet another example, rewards points may be automatically collected for customer 102 who use the service. The rewards points may be dependent on the timing of the service, employees used, resources used, etc. Business automation utilities 132 are not limited to the examples described herein. Business automation utilities 132 may include any utility capable of utilizing the integrated scheduling data and/or rules.

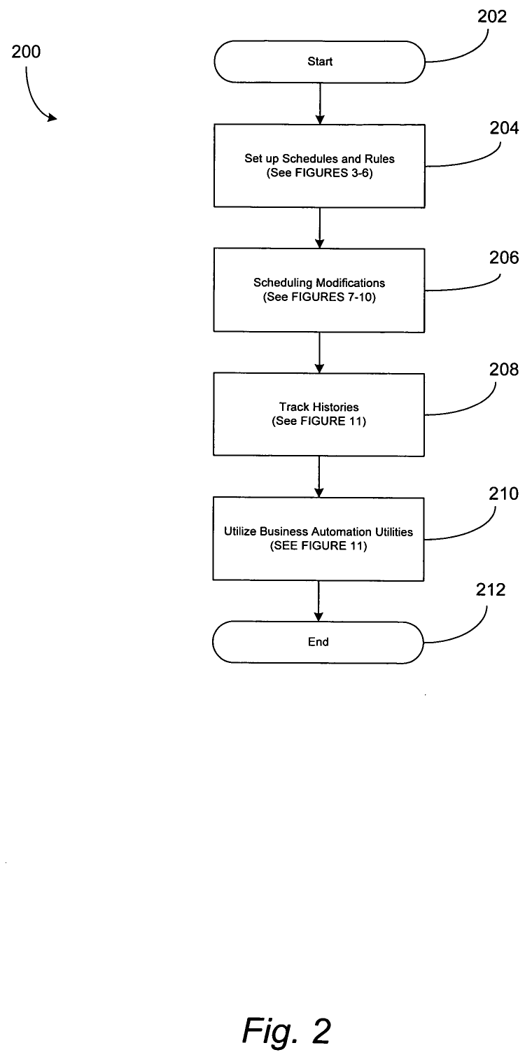

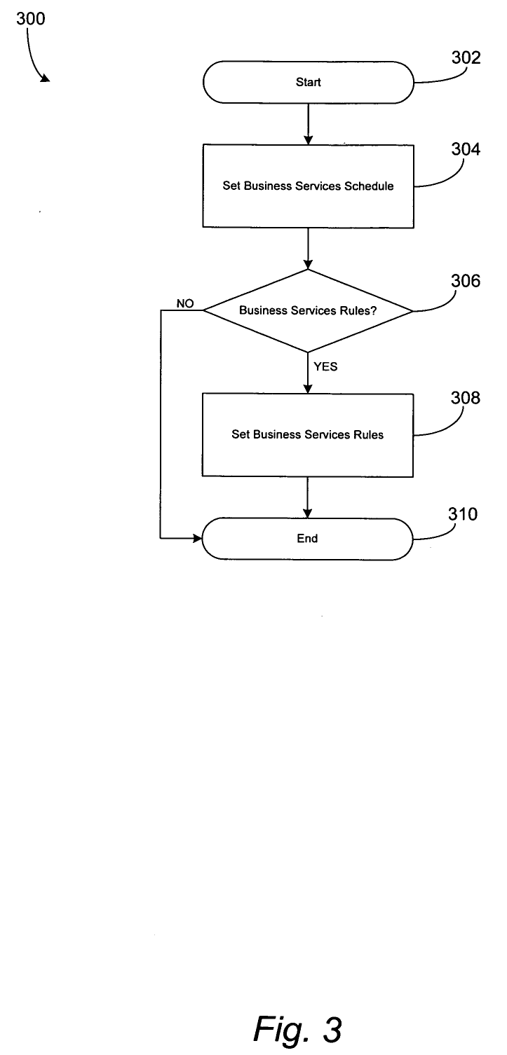

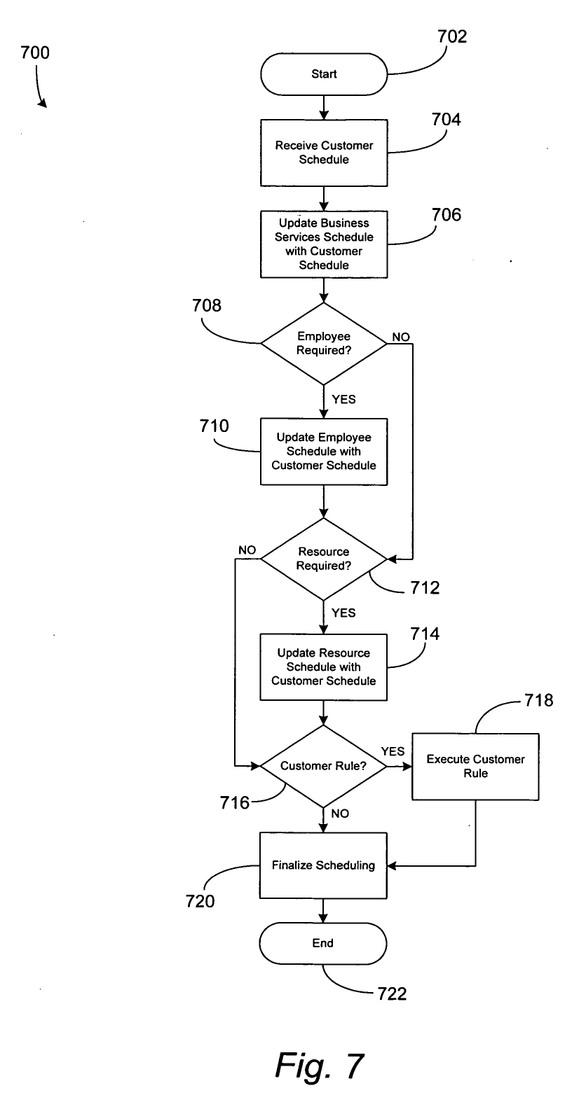

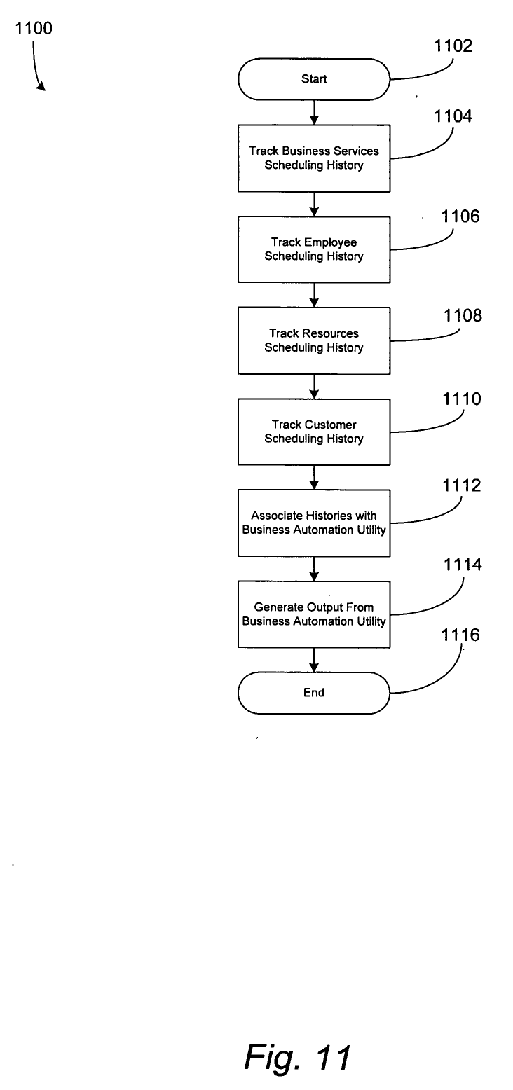

FIG. 2 represents a top level operational flow diagram for scheduling integration for providing business automation. Operational flow 200 begins at start operation 202 and continues to operation 204 where the schedules and the rules for the business entity are set up. Operation 204 is discussed in detail below in FIGS. 3-6. System 200 continues to operation 206 where scheduling modification may occur. Operation 206 is optional. Operation 206 is discussed in detail below in FIGS. 7-10. Operation 208 includes tracking or monitoring scheduling histories. Operation 208 is discussed in further detail in FIG. 11. Operation 210 includes utilizing business automation utilities. Operation 210 is discussed in further detail in FIG. 11. Operational flow 200 then continues to end operation 212.

FIG. 3 represents an operational flow diagram for setting a business service schedule and business service rules. Operational flow 300 begins at start operation 302 and continues to operation 304 where a business services schedule is set. The business services schedule may include hours of service operation. In this manner, the scheduling application confines scheduling of other business entities to the hours of service operation. As an example related to a hair salon, an owner may set the hours of operation for a hair cutting service to Monday through Saturday from 8:00 am to 5:00 pm. The owner may also set the hours of operation for a massage service to Monday through Saturday from 1:00 pm to 5:00 pm. In this manner, scheduling of other entities of the business services are confined to the business service schedule. For example, a reservation request for a haircut on Sunday would be automatically rejected by the program. The business services schedule may also include premium hours of operation. For example, an owner may set a schedule that the owner would be willing to work for a premium (e.g. holiday, conflicted time, etc.). The premium hours of operation may be automatically communicated to the customer.

Operational flow 300 continues to decision operation 306 where it is decided whether to apply business service rules. When business service rules are not applied, operational flow 300 continues to end operation 310. When business service rules are applied, operational flow continues to operation 308 where the business service rules are set. Business service rules include rules that dictate scheduling for business entities. For example, in the hair salon example, Mr. Hatakeda may be a high profile client. The owner of the business service may set a rule that “Mr. Hatakeda receives reservation priority and the most senior employee always handles reservations associated with Mr. Hatakeda.” Accordingly, when Mr. Hatakeda makes a reservation, any conflicting reservations are automatically cancelled and the most senior employee is booked for the reservation. Operational flow 300 then continues to end operation 310.

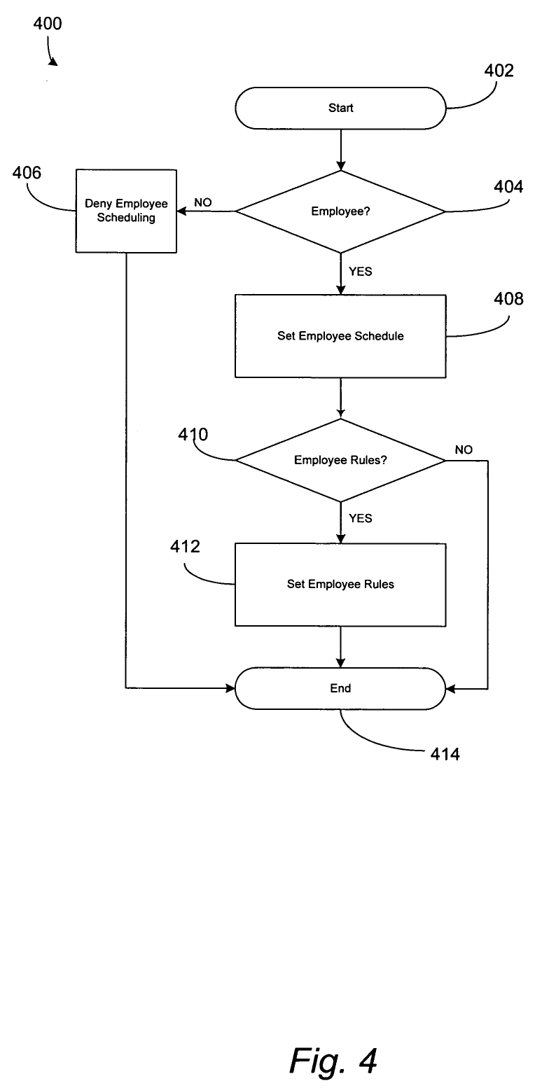

FIG. 4 represents an operational flow diagram for setting an employee schedule and employee rules. Operational flow 400 beings at start operation 402 and continues to decision operation 404. At decision operation 404, it is decided whether the service business includes employees. Decision operation 404 may include determining whether employee data is logged into the scheduling application. If employees do not exist, decision operation 404 continues to operation 406 where employee scheduling is denied. From operation 406, operational flow 400 continues to end operation 414.

When employees exist, operational flow 400 flows from decision operation 404 to operation 408. At operation 408 employee schedules are set. Employee schedules may include the work schedules of the employee. An owner or an employee may set the work schedule. For example, an owner of the hair salon may set the work schedule of Employee Senior to be on Monday from 8 am to 1 pm. The owner of the hair salon may also set a work schedule for Employee Junior to be on Monday from 8 am to 1 pm. Since the employee schedules do not conflict with the business service schedule, the employee schedules may populate in the appropriate calendar of the business service and employees.

Operational flow 400 continues from operation 408 to decision operation 410. At operation 410, it is decided whether employee rules are to be applied. Where employee rules are not applied, operational flow 400 continues to end operation 414. Where employee rules are to be applied, operational flow 400 continues to operation 412. At operation 412, employee rules are set. Employee rules may include rules regarding shift switching. For example, a rule may allow employees to shift switch if another employee is willing and available to take a shift over. The employee rule may require owner permission to shift switch. As an example related to the hair salon, an owner may set an employee rule that “Employee Senior handles reservations from Mr. Hatakeda if Employee Senior is available.” Another rule may include that “Employee Junior handles reservations of Mr. Hatakeda if Employee Senior is not available.” From operation 412, operational flow 400 continues to end operation 414.

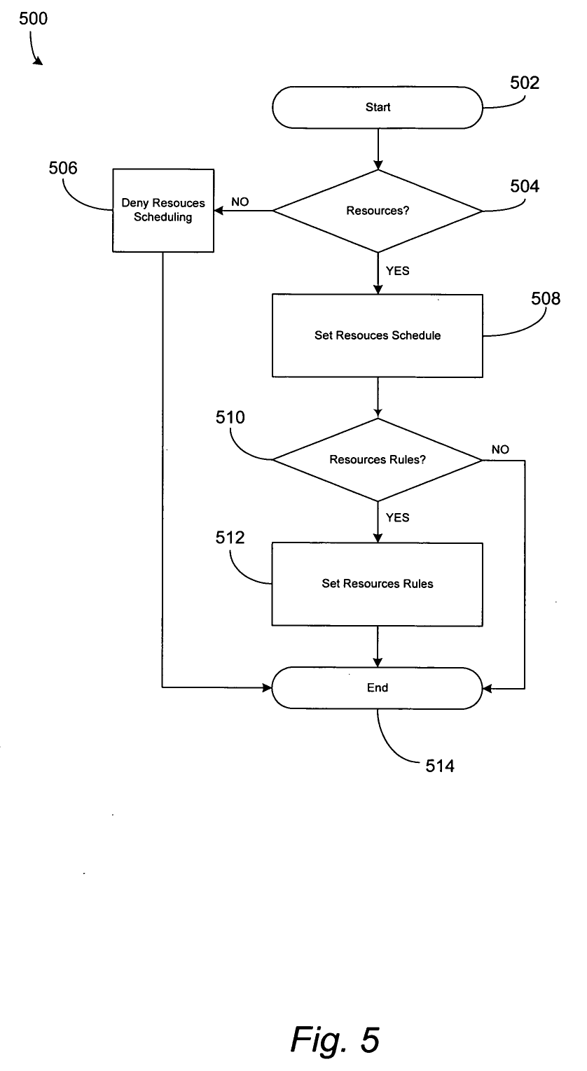

FIG. 5 represents an operational flow diagram for setting a resource schedule and resource rules. Operational flow 500 beings at start operation 502 and continues to decision operation 504. At decision operation 504, it is decided whether the service business include resources. Decision operation 504 may include determining whether resource data is logged into the scheduling application. If resources do not exist, decision operation 504 continues to operation 506 where resource scheduling is denied. From operation 506, operational flow 500 continues to end operation 514.

When resources exist, operational flow 500 flows from decision operation 504 to operation 508. At operation 508 resource schedules are set. Resource schedules may include the availability schedules for the resource. For example the availability schedule for the resource may initially include the hours of operation of the business service. The availability schedule may also take into account when a resource is scheduled or when a resource is unavailable for maintenance. An owner or an employee may set the resource schedule. For example, an owner of the hair salon may set the resource schedule for the president haircutting suite to be equal to the hours of operation of the business service. The owner of the hair salon may also set a resource schedule for a gold hairdryer to be equal to the hours of operation of the business service. Since the resource schedules do not conflict with the business service schedules, the resource schedules may populate in the appropriate calendar of the business service, employees and resources to show availability.

Operational flow 500 continues from operation 508 to decision operation 510. At operation 510, it is decided whether resource rules are to be applied. Where resource rules are not applied, operational flow 500 continues to end operation 514. Where resource rules are to be applied, operational flow 500 continues to operation 512. At operation 512, resource rules are set. Resource rules may include rules regarding the availability and/or priority of resources. With regard to the hair salon example, a resource rule may be implemented that “the gold hairdryer receives priority when it is available.” Another resource rule may include that “if the gold hairdryer is unavailable then the silver hairdryer receives priority.” Another resource rule may include “giving Mr. Hatakeda override priority for the president suite.” From operation 512, operational flow 500 continues to end operation 514.

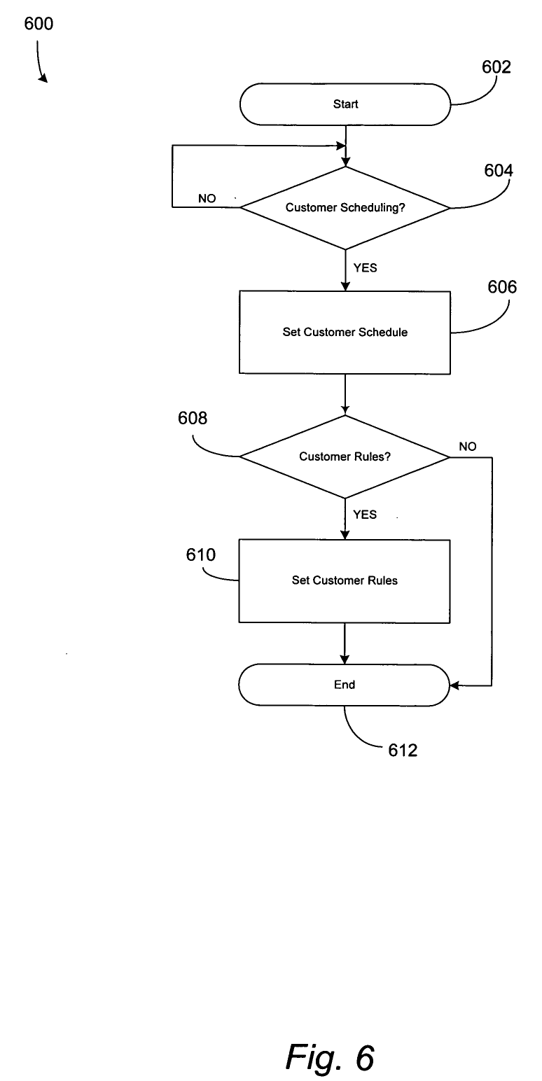

FIG. 6 represents an operational flow diagram for setting a customer schedule and customer rules. Operational flow 600 beings at start operation 602 and continues to decision operation 604. At decision operation 604, it is decided whether the customer scheduling is received. Decision operation 604 may include determining whether a customer has made an online reservation via a reservation service associated with an online presence service. The reservation may also be associated with an email, text message, and/or telephone call. In such a situation, the owner may enter the reservation into the system of FIG. 1. If a reservation is not received, operational flow 600 loops back until a reservation is received. If a reservation is received, operational flow 600 continues to operation 606 where the customer schedule is set.

The customer schedule may be set by populating the customer schedule in the business entity schedules according to the rules. Operational flow 600 continues to decision operation 608 where it is decided whether customer rules apply. Customer rules may be implemented by the business entity to apply to all customers. Customer rules may also be implemented by the customer if the business entity permits individualized customer rules. Customer rules may include requests such as specific employees, resources or services. Customer rules may also indicate a particular mode of communication with the customer. Such modes of communication may include telephone, email, text messaging, regular mail, etc. When customer rules do not apply, operational flow continues to end operation 612.

When customer rules do apply, operational flow 600 continues to operation 610 where the customer rules are set. As an example with the hair salon, Mr. Hatakeda may set a customer rule to “notify him by email if the reservation changes.” If the business service provides for such functionality, Mr. Hatakeda is notified by email for any changes. Operational flow 600 continues to end operation 612.

FIG. 7 represents an operational flow diagram for receiving a customer schedule and updating the service business. Operations in FIG. 7 may be automatic after a customer schedule is received. Operational flow 700 begins at start operation 702 and continues to operation 704. At operation 704, a customer reservation is received. The customer reservation may include customer identification data and a time for the reservation. The customer reservation may also include a customer rule. Operational flow 700 continues to operation 706 where the business services schedule is updated with the customer schedule. As an example related to the hair salon, Mr. Hatakeda may make an online reservation indicating that that he would like a 1 pm hair appointment at the hair salon on Monday. The hair salon receives the reservation and populates the business service schedule to indicate that Mr. Hatakeda has an appointment at 1 pm on Monday.

Operational flow 700 continues to decision operation 708. At decision operation 708, it is decided whether an employee is required for the reservation. An employee may be indicated by a business rule. For example, a business rule may indicate that “all haircuts require a haircut employee.” As another example, a rule may indicate that “all haircuts for Mr. Hatakeda require Employee Senior.” When an employee is not required, operational flow continues to decision operation 712 as is more fully discussed below. When an employee is required, operational flow 700 continues to operation 710.

Employee schedules are updated with the customer schedule at operation 710. The employee may be a requested employee, a free employee, and/or a predetermined employee. Operational flow 700 continues to decision operation 712 where it is decided whether a resource is required. The resource may include any resource needed for the service. The resource may also be determined by a rule. In the hair salon example, the resource may include a haircutting suite and a hair dryer. When a resource is not required, operational flow 700 continues to decision operation 716. When a resource is required, operational flow 700 continues to operation 714. At operation 714, the resource schedule is updated with the customer schedule. In this manner the business owner can keep track of the availability of resources at any given time.

At decision operation 716, it is decided whether a customer rule applies. A customer rule may be set as a business service rule or a customer rule may be received as part of the reservation. The customer rule may include a service request and/or a mode of notification. If a customer rule does not apply, operational flow 700 continues to operation 720 as stated below. If a customer rule applies, operational flow 700 continues to operation 718 where the customer rule is executed. Execution of a customer rule may include setting a notification rule at the business service and/or setting a special request at the business service. Operational flow 700 continues to operation 720 where the scheduling is finalized. In one aspect, the scheduling is finalized by sending a confirmation to the customer in accordance with a customer rule. Operational flow 700 ends at end operation 722.

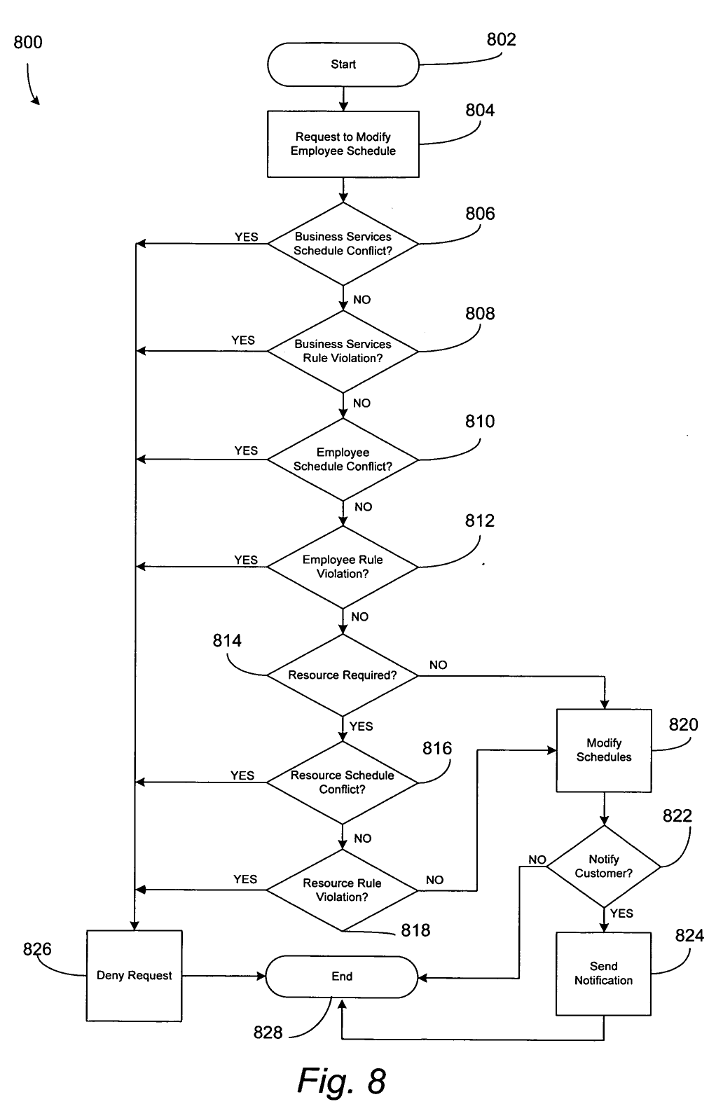

FIG. 8 represents an operational flow diagram for modifying an employee schedule. Operations in FIG. 8 may be automatic after a modification request is received. Operational flow 800 begins at start operation 802 and continues to operation 804 where an employee or owner requests to modify an employee schedule. For example, an employee may log onto the system of FIG. 1 and desire canceling a Monday shift and adding a Thursday shift.

Operational flow 800 continues to decision operation 806. At decision operation 806, it is determined whether a business services schedule conflict exists. For example, a business services schedule conflict may exist when the business is not open during the proposed schedule shift. In such a situation, operational flow 800 continues to operation 826 where the modification request is denied. When a business service schedule conflict does not exist, operational flow 800 continues to decision operation 808.

At decision operation 808, it is decided whether a business service rule is violated. For example, a business service rule may include prohibiting employees for changing the schedule. Other business service rules may include locking an employees schedule so that certain portions of the schedule cannot be change. If a business services rule violation exists, operational flow 800 continues to operation 826 where the modification request is denied. When a business services rule violation does not exist, operational flow 800 continues to decision operation 810.

At decision operation 810, it is decided whether there is a employee schedule conflict. For example, an employee schedule conflict may exist where the proposed shift change conflicts with another employee's shift. If a conflict exists, operational flow 800 continues to operation 826 where the request is denied. When an employee schedule conflict does not exist, operational flow 800 continues to decision operation 812.

At decision operation 812, it is decided whether an employee rule violation exists. For example, an employee rule may include associating a particular employee with a particular customer. If an employee rule violation exists, operational flow 800 continues to operation 826 where the modification is denied. When an employee rule violation does not exist, operation flow 800 continues to decision operation 814.

At decision operation 814, it is decided whether a resource has been required for the service. If not, operational flow 800 continues to operation 820 as is more fully set forth below. If a resource has been required, operational flow 800 continues to operation 816 where it is determined if a resource schedule conflict exists. A resource schedule conflict may exist when the proposed modification requires a double booking of the same resource at the same time. If a conflict exists, operational flow 800 continues to operation 826 where the request is denied. If a conflict does not exist, operational flow 800 continues to decision operation 818.

At decision operation 818, it is decided whether a resource rule violation exists. A resource rule violation may exist when a rule dictates that the proposed schedule would cause a resource to be made unavailable. If a violation exists, operational flow 800 continues to operation 826 where the request is denied. If a violation does not exist, operational flow 800 continues to operation 820 where the schedule is modified. Stated another way, an employee is allowed to added, cancel, and/or switch the shift. Operational flow 800 continues to decision operation 822 where it is decided whether a customer requires notification. A customer may require notification when the customer has requested a particular employee and the employee is no longer available because of the modification. If notification is required, operational flow 800 continues to operation 824 where the notification is sent to the customer. Operational flow 800 ends at end operation 828.

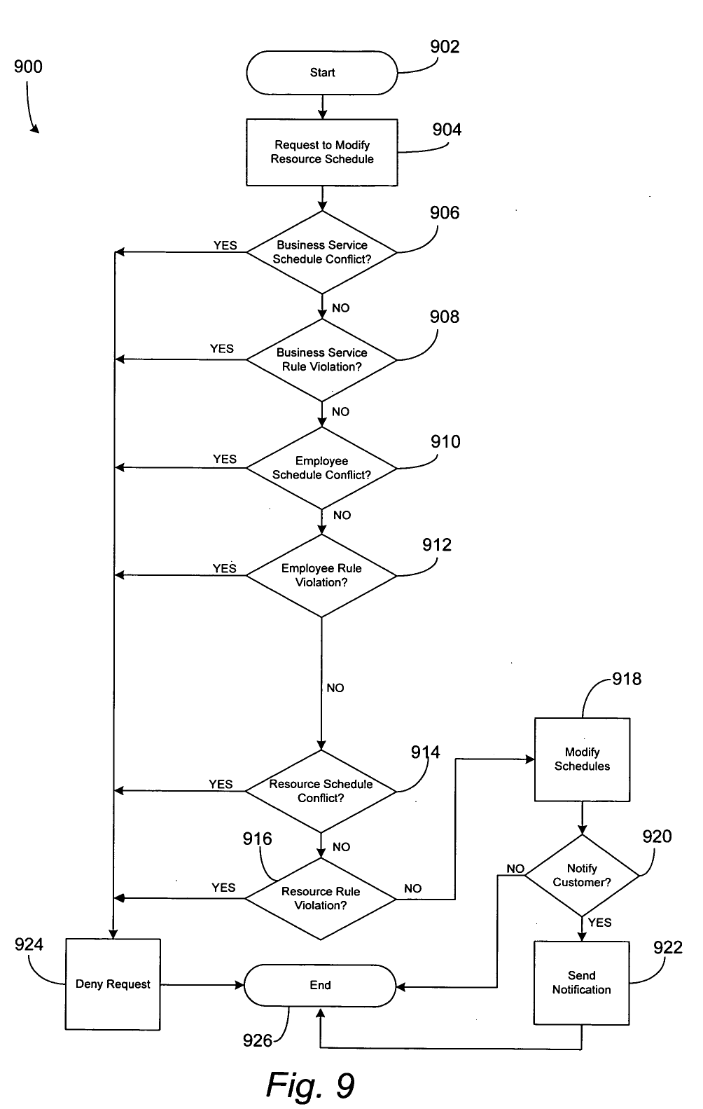

FIG. 9 represents an operation flow diagram for modifying a resource schedule. Operations in FIG. 9 may be automatic after a modification request is received. Operational flow 900 begins at start operation 902 and continues to operation 904 where an employee or owner requests to modify a resource schedule. For example, an employee may log onto the system of FIG. 1 and desire adding the use of a presidential haircutting suite.

Operational flow 900 continues to decision operation 906. At decision operation 906, it is determined whether a business services schedule conflict exists. For example, a business services schedule conflict may exist when the business is not open during the proposed use of the resource. In such a situation, operational flow 900 continues to operation 924 where the modification request is denied. When a business service schedule conflict does not exist, operational flow 900 continues to decision operation 908.

At decision operation 908, it is decided whether a business service rule is violated. For example, a business service rule may include prohibiting employees from changing adding resources. Other business service rules may include locking a resource to a particular employee. If a business services rule violation exists, operation flow 900 continues to operation 924 where the modification request is denied. When a business services rule violation does not exist, operational flow 900 continues to decision operation 910.

At decision operation 910, it is decided whether there is an employee schedule conflict. For example, an employee schedule conflict may exist where the proposed resource use conflicts with the use by another employee. If a conflict exists, operational flow 900 continues to operation 924 where the request is denied. When an employee schedule conflict does not exist, operational flow 900 continues to decision operation 912.

At decision operation 912, it is decided whether an employee rule violation exists. For example, an employee rule may include associating a particular resource with a particular employee. If an employee rule violation exists, operational flow 900 continues to operation 924 where the modification is denied. When an employee rule violation does not exist, operational flow 900 continues to decision operation 914.

At decision operation 914, it is determined if a resource schedule conflict exists. For example, a resource schedule conflict may exist when the proposed modification requires a double booking of the same resource at the same time. If a conflict exists, operational flow 900 continues to operation 924 where the request is denied. If a conflict does not exist, operational flow 900 continues to decision operation 916.

At decision operation 916, it is decided whether a resource rule violation exists. A resource rule violation may exist when a rule dictates that the proposed schedule would cause a resource to be made inappropriately unavailable. If a violation exists, operational flow 900 continues to operation 924 where the request is denied. If a violation does not exist, operational flow 900 continues to operation 918 where the schedule is modified. Stated another way, a resource may be added, modified, cancelled or switched. Operational flow 900 continues to decision operation 920 where it is decided whether a customer requires notification. A customer may require notification when the customer has requested a particular resource and the resource is no longer available because of the modification. If notification is required, operational flow 900 continues to operation 922 where the notification is sent to the customer. Operational flow 900 ends at end operation 926.

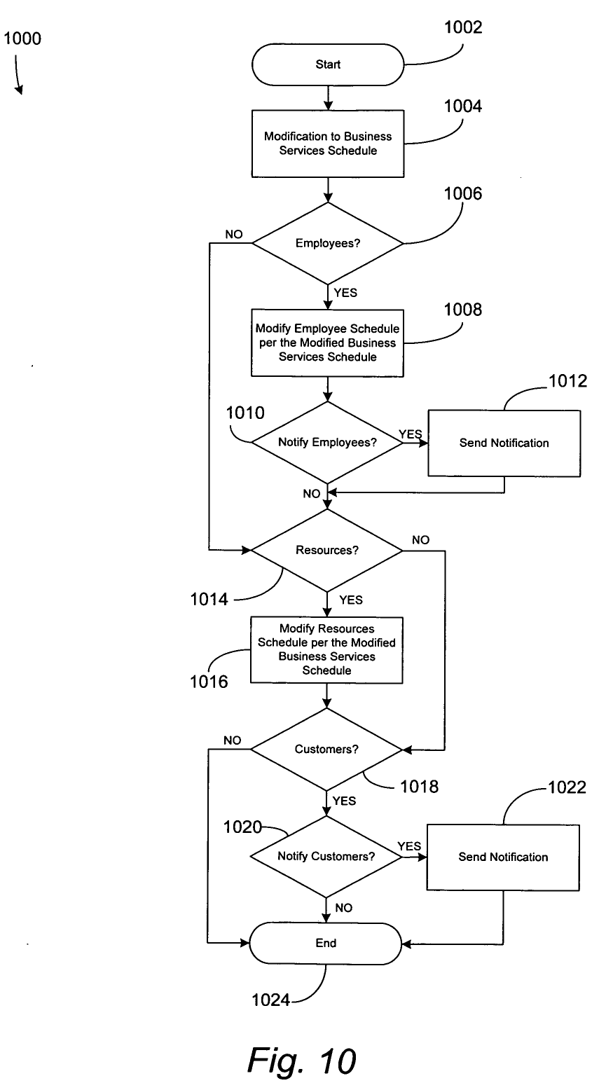

FIG. 10 represents an operation flow diagram for modifying a business services schedule. Operations in FIG. 10 may be automatic after a modification request is received. Operational flow 1000 begins at start operation 1002 and continues to operation 1004 where the business services schedule is modified. For example, an owner may close the business service for a day that it was scheduled to be open.

Operational flow 1000 continues to decision operation 1006 where it is determined whether employees are associated with the business service. If not, operational flow 1000 continues to decision operation 1014 as more fully set forth below. If employees are associated with the business service, operational flow 1000 continues to operation 1008. At operation 1008, employee schedules are modified per the modified business services schedule. For example, employee schedules for the cancelled day may be cancelled. Also, shifts may be added to make up for the modified business services schedule.

Operational flow 1000 continues to decision operation 1010 where it is decided whether to notify employees of the modified business services schedule. If not, operational flow continues to decision operation 1014. If notification is desired, operational flow 1000 continues to send notification 1012 where a notification is sent to the employees. In one aspect, the notification is sent via a notification mode associated with a rule. Operational flow 1000 continues to decision operation 1014.

At decision operation 1014, it is determined whether resources are associated with the business service. If not, operational flow 1000 continues to decision operation 1018 as more fully set forth below. If resources are associated with the business service, operational flow 1000 continues to operation 1016. At operation 1016, resource schedules are modified per the modified business services schedule. For example, resource schedules for the cancelled day may be cancelled. Also, resource availability may be added to make up for the modified business services schedule.

Operational flow 1100 continues to decision operation 1018 where it is determined whether customers are associated with the business service. If not, operational flow 1000 continues to end operation 1024 as more fully set forth below. If customers are associated with the business service, operational flow 1000 continues to operation 1020 where it is decided whether to notify customers of the modified business services schedule. If not, operational flow continues to end operation 1024. If notification is desired, operational flow 1000 continues to send notification 1022 where a notification is sent to the customer. In one aspect, the notification is sent via a notification mode associated with a rule. Operational flow 1000 continues to end operation 1024.

FIG. 11 represents an operation flow diagram for utilizing a business automation utility. Operational flow 1100 begins at start operation 1102 and continues to operation 1104 where business services schedules are tracked. For example, operation 1104 may include tracking business service schedules over a period of time. Operational flow 1100 continues to operation 1106 where employee schedules are tracked. For example, employee schedules may be tracked per employee and/or over a period of time. Operational flow 1100 continues to operation 1108 where resource schedules are tracked. For example, resource schedules may be tracked per resource and/or over a period of time. Operational flow 1100 continues to operation 1110 where customer schedules are tracked. For example, customer schedules may be tracked per customer and/or over a period of time. The schedules may be tracked individually or in relation to one another.

Operational flow 1000 continues from operation 1110 to operation 1112. At operation 1112 data associated with the tracking of the schedules is associated with a business automation utility. A business automation utility may include a calendaring application, a chart application, a spreadsheet application, a survey application, a coupon application, a reward point application, and/or any application configured to utilize data from schedules.

At operation 1114 an output is generated from the business automation utility. For example, a calendaring application may include a calendar having a global schedule for all the individual schedules of the business entity. As another example, a chart application may chart business entities and scheduling in relation to one another. As yet another example, a spreadsheet application may include a spreadsheet of the use of employees and resources over a time period. As still another example, a survey application may be configured to generate a service, customer, employee and resource specific survey. In this manner, a business owner may obtain very specific data of a service. As still another example, a coupon application may be sent to customers according to a specific notification rule associated with a customer rule. The coupon may also be traceable via a bar code and be transferable. In this manner, a customer may transfer the coupon to another individual. When the individual uses a business service, a business service can trace the coupon back to the customer. The coupon may have a unique code or barcode associated therewith. As yet another example, rewards points may be automatically collected for a customer who uses the service. The rewards points may be dependent on the timing of the service, employees used, resources used, etc. Business automation utilities are not limited to the examples described herein. Business automation utilities may include any utility capable of utilizing the integrated scheduling data and/or rules. Operational flow 1100 ends at end operation 1116.

In reference to the operations associated with FIGS. 1-11, a generalized example relating to a hair salon is discussed herein. A service business owner sets hours of operation for the service to Monday through Saturday from 8 am to 5 pm. The business owner also sets a business rule that a reservation from Mr. Hatakeda is addressed by Employee Senior if Employee Senior is available. If Employee Senior is not available, then a reservation from Mr. Hatakeda is addressed by Employee Junior.

The business owner sets the work schedules for Employee Senior and Employee Junior. Employee Senior has a work schedule from 1 pm-5 pm on Monday and Employee Junior has a work schedule from 1 pm-5 pm on Monday. The business owner also sets an employee rule that indicates that employees may switch shifts without permission.

The business owner sets the resource schedules for the resources of the business. The schedule for the president haircutting suite is open, the schedule for the gold hairdryer is open and the schedule for the silver hairdryer is open because reservations have not yet been made. The business owner also sets a resource rule that indicates that if Mr. Hatakeda makes a reservation he receives priority to the president haircutting suite and the gold hair dryer. If the gold hair dryer is in maintenance than Mr. Hatakeda has priority to the silver hair dryer.

Mr. Hatakeda decides that he needs a haircut. Mr. Hatakeda logs onto his home computer and enters a website associated with an online presence service. The online presence service allows Mr. Hatakeda to book a reservation with the haircutting service. Mr. Hatakeda books a reservation for 2 pm on Monday. Mr. Hatakeda also sets a rule that change notifications should be sent via email.

The business service receives the reservation from Mr. Hatakeda. The business service schedule is populated with the reservation information and the notification rule is associated with the business service rule so that the business service sends any modifications to Mr. Hatakeda via email. The schedule for Employee Senior is populated in light of the business service rule dictating the same. The president suite and the gold hairdryer are reserved for the time during the reservation. Mr. Hatakeda is sent an email confirmation indicating that his haircut is on Monday at 2 pm with Employee Senior in the president haircutting suite with the gold hairdryer.

On the Friday before Mr. Hatakeda's haircut appointment, Employee Senior alters the employee schedule to indicate that Employee Senior will not be working on Monday. Also on the Friday before Mr. Hatakeda's haircut appointment, the gold hairdryer stops functioning. Employee Junior agrees to cover Employee Senior's customers. Employee Senior's schedule automatically clears and Employee Junior's Schedule populates with the reservation of Mr. Hatakeda. The schedule for the gold hairdryer clears and the schedule for the silver hairdryer automatically populates. An email notification is automatically generated and sent to Mr. Hatakeda. The email notification indicates that his haircut has been changed to Monday at 2 pm with Employee Junior in the president haircutting suite with the silver hairdryer.

The survey application tracks the scheduling and changes in scheduling. The survey application tracks Mr. Hatakeda's reservation, and the changes with a reservation. The survey is then personalized to appologize for the changed reservation and asking Mr. Hatakeda to comment on his haircut on Monday at 2 pm with Employee Junior in the president haircutting suite with the silver hairdryer.

As indicated herein, the disclosure provides scheduling enhancement, custom relations management is enhanced, employee relations management is enhanced and scheduling data may be leveraged to provide enhanced business utilities.

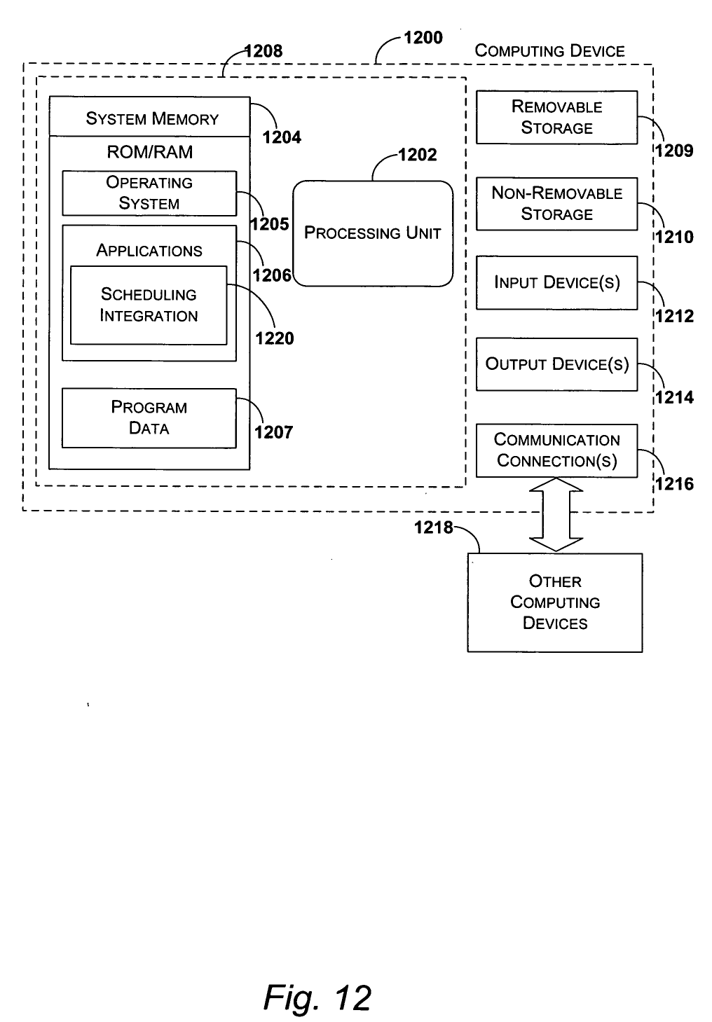

Referring to FIG. 12, an exemplary system for implementing the invention includes a computing device, such as computing device 1200. In a basic configuration, computing device 1200 may include any type of stationary computing device or a mobile computing device. Computing device 1200 typically includes at least one processing unit 1202 and system memory 1204. Depending on the exact configuration and type of computing device, system memory 1204 may be volatile (such as RAM), non-volatile (such as ROM, flash memory, and the like) or some combination of the two. System memory 1204 typically includes operating system 1205, one or more applications 1206, and may include program data 1207. In one embodiment, applications 1206 further include application 1220 for scheduling integration. This basic configuration is illustrated in FIG. 12 by those components within dashed line 1208.

Computing device 1200 may also have additional features or functionality. For example, computing device 1200 may also include additional data storage devices (removable and/or non-removable) such as, for example, magnetic disks, optical disks, or tape. Such additional storage is illustrated in FIG. 1 by removable storage 1209 and non-removable storage 1210. Computer storage media may include volatile and non-volatile, removable and non-removable media implemented in any method or technology for storage of information, such as computer readable instructions, data structures, program modules or other data. System memory 1204, removable storage 1209 and non-removable storage 1210 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 1200. Any such computer storage media may be part of device 1200. Computing device 1200 may also have input device(s) 1212 such as a keyboard, mouse, pen, voice input device, touch input device, etc. Output device(s) 1214 such as a display, speakers, printer, etc. may also be included.

Computing device 1200 also contains communication connection(s) 1216 that allow the device to communicate with other computing devices 1218, such as over a network or a wireless network. Communication connection(s) 1216 is an example of communication media. Communication media typically embodies computer readable instructions, data structures, program modules or other data in a modulated data signal such as a carrier wave or other transport mechanism and includes any information delivery media. The term “modulated data signal” may include a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. The term computer readable media as used herein includes both storage media and communication media.

Although the invention has been described in language that is specific to structural features and/or methodological steps, it is to be understood that the invention defined in the appended claims is not necessarily limited to the specific features or steps described. Rather, the specific features and steps are disclosed as forms of implementing the claimed invention. Since many embodiments of the invention can be made without departing from the spirit and scope of the invention, the invention resides in the claims hereinafter appended.

What is claimed is:

1. A computer-implemented method for providing integrated business automation tools through schedule integration, the method comprising:
providing a business service schedule and a business service rule for a business service, wherein the business service rule includes a rule governing the allocation of reservations to employees of the business;
providing an employee schedule for an employee of the business;
receiving a reservation from a customer, wherein the reservation includes a time and date for a service;
automatically updating the business service schedule with the time and date for the service; and
automatically updating the employee schedule with the time and date for the service, wherein the time and date are updated to the employee schedule in accordance with the business service rule.

2. The computer-implemented method of claim 1, further comprising:
providing an employee rule associated with the employee of the business;
receiving a modification to the employee schedule;
automatically determining whether the modification conflicts with the employee rule;
automatically rejecting the modification when the modification conflicts with the employee rule; and
automatically allowing the modification when the modification does not conflict with the employee rule.

3. The computer-implemented method of claim 2, further comprising:
notifying the customer according to a customer rule when the modification is allowed.

4. The computer-implemented method of claim 1, further comprising:
providing a resource schedule for a resource of the business; and
updating the resource schedule with the time and date for the service, wherein the time and date are updated to the resource schedule in accordance with the business service rule.

5. The computer-implemented method of claim 1, further comprising:
providing a resource rule associated with the resources of the business;
receiving a modification to the resource schedule;
automatically determining whether the modification conflicts with the resource rule;
automatically rejecting the modification when the modification conflicts with the resource rule; and
automatically allowing the modification when the modification does not conflict with the resource rule.

6. The computer-implemented method of claim 5, further comprising:
notifying the customer according to a customer rule when the modification is allowed.

7. The computer-implemented method of claim 1, wherein the reservation includes a customer rule that indicates a mode of notification.

8. The computer-implemented method of claim 1, further comprising:
monitoring the business service schedule and employee schedule to generate customized reports associated with a business automation utility.

9. The computer-implemented method of claim 1, further comprising:
providing a resource schedule for resources of the business;
updating the resource schedule with the time and date for the service, wherein the time and date are updated to the resource schedule in accordance with the business service rule;
providing an employee rule associated with the employee of the business;
providing a resource rule associated with the resources of the business;
receiving an employee modification to the employee schedule;
automatically determining whether the employee modification conflicts with the employee rule;
automatically rejecting the employee modification when the employee modification conflicts with the employee rule;
automatically allowing the employee modification when the employee modification does not conflict with the employee rule;
receiving a resource modification to the resource schedule;
automatically determining whether the resource modification conflicts with the resource rule;
automatically rejecting the resource modification when the resource modification conflicts with the resource rule; and
automatically allowing the resource modification when the resource modification does not conflict with the resource rule.

10. The computer-implemented method of claim 1, wherein the business includes an online presence service for providing online reservation utilities to the customer.

11. A computer-readable storage medium having computer-executable instructions for providing integrated business automation tools through schedule integration, the instructions comprising:
providing a business service schedule and a business service rule for a business service, wherein the business service schedule includes the hours and dates of operation of the business service, wherein the business service rule includes a rule governing the allocation of reservations to employees of the business;
providing an employee schedule and an employee rule for an employee of the business, wherein the employee schedule includes work shifts for the employee, wherein the employee rule includes an employee schedule modification rule governing modification of the employee schedule;
providing a resource schedule and a resource rule for resources of the business, wherein the resource schedule includes resource availability for the resources, wherein the resource rule includes a resource modification rule governing modification of the resource schedule;
receiving a reservation from a customer, wherein the reservation includes a time and date for a service;
updating the business service schedule with the time and date for the service;
updating the employee schedule with the time and date for the service, wherein the time and date are updated to the employee schedule in accordance with the business service rule; and
updating the resource schedule with the time and date for the service, wherein the time and date are updated to the resource schedule in accordance with the business service rule.

12. The computer-readable storage medium of claim 11, further comprising:
receiving a modification to the business service schedule;
automatically modifying the employee schedule according to the modification;
automatically modifying the resource schedule according to the modification;
automatically notifying the employee of the business according to an employee notification rule; and
automatically notifying customers according to a customer notification rule.

13. The computer-readable storage medium of claim 11, further comprising:
receiving a modification to the employee schedule;
automatically determining whether the modification conflicts with the employee rule;
automatically denying the modification when the modification conflicts with the employee rule; and
automatically setting the modification in the employee schedule when the modification does not conflict with the employee rule.

14. The computer-readable storage medium of claim 13, further comprising:
notifying the customer according to a customer rule when the modification is allowed.

15. The computer-readable storage medium of claim 11, further comprising:
receiving a modification to the resource schedule;
automatically determining whether the modification conflicts with the resource rule;
automatically denying the modification when the modification conflicts with the resource rule; and
automatically setting the modification in the resource schedule when the modification does not conflict with the resource rule.

16. The computer-readable storage medium of claim 15, further comprising:
notifying the customer according to a customer rule when the modification is allowed.

17. A system for providing integrate business automation tools through schedule integration, the instructions comprising:
a processor; and
a memory having computer executable instructions associated therewith, wherein the computer executable instructions are configured to:
provide a business service schedule and a business service rule for a business service;
provide an employee schedule and an employee rule for an employee of the business;
provide a resource schedule and a resource rule for resources of the business;
receive a reservation from a customer, wherein the reservation includes a time for a service;
automatically update the business service schedule with the time for the service;
automatically update the employee schedule with the time for the service, wherein the time is updated to the employee schedule in accordance with the business service rule;
automatically update the resource schedule with the time for the service, wherein the time is updated to the resource schedule in accordance with the business service rule;
monitor the business service schedule, the employee schedule and the resource schedule to generate schedule history data; and
utilizing the schedule history data to generate a reservation specific report.

18. The system of claim 17, wherein the reservation specific report includes at least one member of a group comprising: a calendar report, a chart report, a spreadsheet report, a survey, a coupon and a reward report.

19. The system of claim 17, wherein the reservation includes a customer identification a customer notification rule.

20. The system of claim 19, wherein the customer notification rule includes a rule requiring customer notification by at least one member of a group comprising: an email, a text message, a telephone call, and regular mail.
